(19) United States
(12) Patent Application Publication
(10) Pub. No.: US 2012/0197628 A1
(43) Pub. Date: Aug. 2, 2012

(54) CROSS-LANGUAGE SPELL CHECKER

(75) Inventors: Steven F. Best, Groton, MA (US); Stanley K. Jerrard-Dunne, Dublin (IE); Janice M. Girouard, Austin, TX (US); Timothy B. Snow, Westford, MA (US)

(73) Assignee: International Business Machines Corporation, Armonk, NY (US)

(21) Appl. No.: 13/016,584

(22) Filed: Jan. 28, 2011

(51) Int. Cl. G06F 17/28

(52) U.S. Cl. 704/2

(57) ABSTRACT

Embodiments of the present invention provide a method, system and computer program product for multi-lingual support during spell checking of a block of text. In an embodiment of the invention, a method for multi-lingual spell checking of a block of text is provided. The method includes spell checking text of a source language such as a word in a source language in a block of text of the source language in a computer program executing in memory of a host computer. The method further includes locating suggested correctly spelled text for the spell checked text in a dictionary for the source language. The method yet further includes translating the located suggested correctly spelled text into a translation of the located suggested correctly spelled text in a secondary language. Finally, the method includes displaying both the located suggested correctly spelled text in the source language and the translation of the located suggested correctly spelled text in the secondary language in connection with the spell checked text.

### BACKGROUND OF THE INVENTION

1. Field of the Invention

The present invention relates to spell checking a document and more particularly to multi-lingual support during a spell checking operation.

2. Description of the Related Art

In computing, a spell checker is a computer program or a module of a computer program that detects words in a document or in a field of a form that may not be spelled correctly. A spell checker customarily includes both a set of logical routines for scanning text and extracting words (parsing), and a for comparing the parsed words against a known list of correctly spelled words—namely a dictionary. Depending upon the computer program supported by the spell checker, the dictionary can be limited to a discrete set of application specific words, or the dictionary can be an exhaustive representation of the words of a language. Advanced forms of the spell check even can provide for hyphenation points, lexical and grammatical attributes and in some cases, synonym and antonyms to the words. Most spell checkers additionally provide for user modification to the dictionary or user supplementation of the dictionary with a user dictionary to account for words known to the user to be spelled correctly though indicated otherwise in the spell checker dictionary.

Of note, spell checkers can accommodate multiple different languages by virtue of a supplied dictionary. In this regard, while the core logic of the spell checker can remain static for the most part, the dictionary supplied with the spell checker largely determines language support for the spell checker. At present, the dictionaries distributed with a spell checker or unilingual in nature. In all likelihood, spell checkers remain unilingual primarily because the nuances of language vary from language to language thus complicating the process of parsing blocks of text and identifying an incorrectly spelled word notwithstanding language specific annotations to the words of the block of text, such as possessive tense notations, hyphenation, accents, diacritical marks and the like.

To accommodate multi-lingual requirements during document processing, end users frequently use separate dictionary tools that are multilingual in nature. For example, many dictionaries provide not only an entry for a word in the source language of the dictionary, but also alternative translations of the word into different languages just like the dictionary will provide synonyms for the word in the source language. Yet, utilizing two separate tools during document processing is a substantial inconvenience to many end users. Ironically, even computerized language learning tools lack the capability of performing multi-lingual spell checks.

### BRIEF SUMMARY OF THE INVENTION

Embodiments of the present invention address deficiencies of the art in respect to spell checking and provide a novel and non-obvious method, system and computer program product for multi-lingual support during spell checking of a block of text. In an embodiment of the invention, a method for multi-lingual spell checking of a block of text is provided. The method includes spell checking text of a source language such as a word in a source language in a block of text of the source language in a computer program executing in memory of a host computer. The method further includes locating suggested correctly spelled text for the spell checked text in a dictionary for the source language. The method yet further includes translating the located suggested correctly spelled text into a translation of the located suggested correctly spelled text in a secondary language. Finally, the method includes displaying both the located suggested correctly spelled text in the source language and the translation of the located suggested correctly spelled text in the secondary language in connection with the spell checked text.

In one aspect of the embodiment, the method further can include selecting the located suggested correctly spelled text in the source language, locating in the dictionary for the source language a synonym for the located suggested correctly spelled text in the source language, additionally locating in a dictionary for the secondary language a synonym for the translation of the located suggested correctly spelled text in the secondary language, and displaying both the synonym in the source language and the synonym in the secondary language in connection with the spell checked text. In another aspect of the embodiment, the method further can include selecting the located suggested correctly spelled text in the source language, locating in the dictionary for the source language a definition for the located suggested correctly spelled text in the source language, additionally locating in a dictionary for the secondary language a definition for the translation of the located suggested correctly spelled text in the secondary language, and displaying both the definition in the source language and the definition in the secondary language in connection with the spell checked text.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for multi-lingual spell checking of a block of text;

FIG. 2 is a schematic illustration of a text data processing system configured for multi-lingual support during spell checking of a block of text; and,

FIG. 3 is a flow chart illustrating a process for multi-lingual spell checking of a block of text.

### DETAILED DESCRIPTION OF THE INVENTION

Embodiments of the invention provide for multi-lingual support during spell checking of a block of text. In accordance with an embodiment of the invention, a spell checker can be invoked for text of a source language in a block of text in the source language in a display of a computer program. The text can be compared to a dictionary of the source language to determine whether or not the text has been misspelled. If it is determined that the text has been misspelled, a suggestion for a correct spelling of the text in the source language can be displayed in the computer program. Additionally, a translation of the suggestion for the correct spelling of the text into a secondary language can be displayed in conjunction with the display of the suggestion for the correct spelling of the text in the source language.

Optionally, a definition for the text can be provided in the source language in connection with the suggestion for the correct spelling of the text in the source language. Likewise, a definition for the text can be provided in the secondary language in connection with the suggestion for the correct spelling of the text in the secondary language. As yet another option, one or more synonyms can be provided in the source language in connection with the suggestion for the correct spelling of the text in the source language. Likewise, one or more synonyms can be provided in the secondary language in connection with the suggestion for the correct spelling of the text in the secondary language. In this way, multilingual support can be integrated into the spell checker of the computer program.

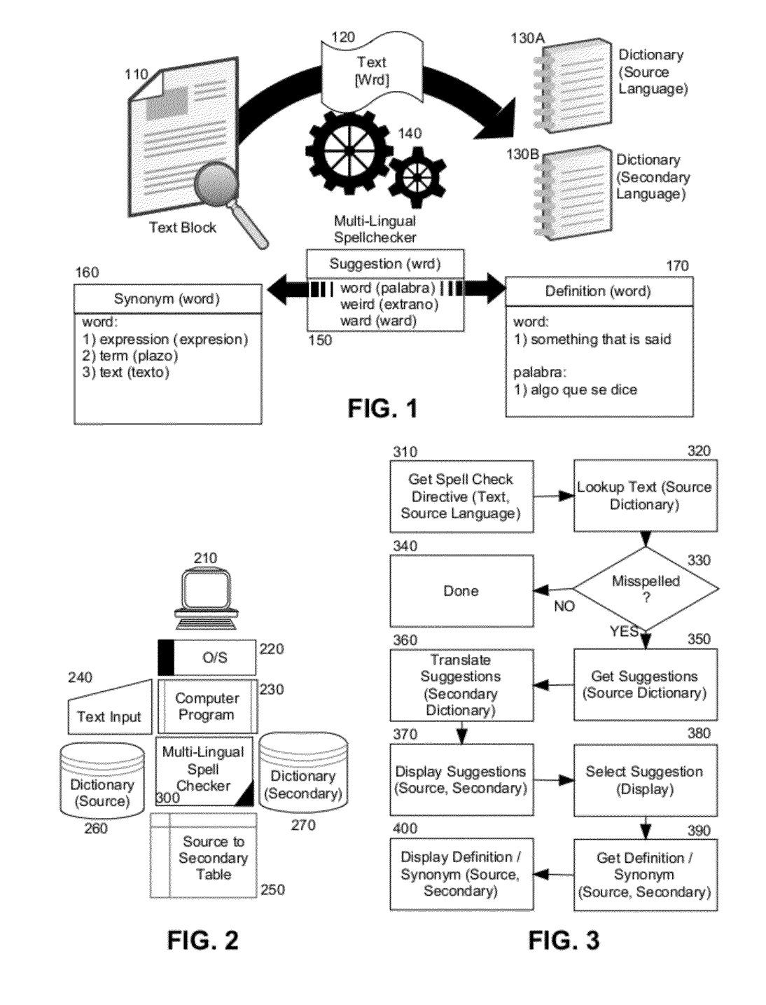

In further illustration, FIG. 1 pictorially shows a process for multi-lingual spell checking of a block of text. As shown in FIG. 1, a multi-lingual spell checker 140 can spell check text 120 in a block of text 110, such as text in a field of a computer program, or text in a document in a document processor. The text 120 can include a single word, or a string of multiple words. The multi-lingual spell checker 140 can compare the text 120 to a dictionary 130A for a source language common to the text 120. In response to detecting a misspelling of the text 120, the multi-lingual spell checker can generate a suggestion prompt 150 for the text 120 suggesting possible correct spellings drawn from the dictionary 130A. Further, for each suggested word in the prompt 150, a dictionary 130B in a secondary language can be consulted to include in the prompt 150 a foreign language equivalent for each suggestion.

In response to a selection of one of the suggested words in the prompt 150, the dictionary 130A can be consulted to locate a definition for the selected suggested word. Further, the dictionary 130B can be consulted to locate a definition in a secondary language for the foreign language equivalent of the selected suggested word. Both definitions can be placed in a definitions prompt 170. Alternatively, in response to a selection of one of the suggested words in the prompt 150, the dictionary 130A can be consulted to locate one or more synonyms for the selected suggested word. Further, the dictionary 130B can be consulted to locate one or more synonyms in a secondary language for the foreign language equivalent of the selected suggested word. Both sets of synonyms can be placed in a synonyms prompt 160.

The process described in connection with FIG. 1 can be implemented in a text data processing system such as a word processing system, or foreign language learning program, or the like. In further illustration, FIG. 2 schematically shows a text data processing system configured for multi-lingual support during spell checking of a block of text. The system can include a host computer 210 with at least one processor and memory supporting the execution of an operating system 220. The operating system 220 in turn can host the operation of a computer program 230 providing a text input display area into which text input 240 can be provided by an end user.

A multi-lingual spell checker 300 can be coupled to the computer program 230 and also to each of a dictionary for a source language 260, a dictionary for a secondary language 270, and a translation table 250 (such as another source language-to-secondary language dictionary). The multi-lingual spell checker 300 can include program code enabled upon execution in the host computer 210 to detect a misspelled word in a source language within the text input 240, to locate one or more suggested correctly spelled words in the dictionary for the source language 260, to translate each suggested correctly spelled word using the translation table 250, and to present the suggested correctly spelled words in both the source language and secondary language in the computer program 230.

Optionally, the program code of the multi-lingual spell checker 300 can be enabled upon selection of a suggested word, to lookup in the dictionary of the source language 260 a set of synonyms for the suggested word, and to lookup in the dictionary of the secondary language 270 a set of synonyms for the translated form of the suggested word. As yet another option, the program code of the of the multi-lingual spell checker 300 can be enabled upon selection of a suggested word, to lookup in the dictionary of the source language 260 a definition for the suggested word, and to lookup in the dictionary of the secondary language 270 a definition for the translated form of the suggested word.

In even yet further illustration of the operation of the multi-lingual spell checker, FIG. 3 is a flow chart illustrating a process for multi-lingual spell checking of a block of text. Beginning in block 310, a spell check directive can be received for text in a text block of a source language. In block 320, the text can be spell checked in connection with a dictionary of the source language. In decision block 330, if the text is not misspelled, the process can end in block 340. Otherwise, in block 350, suggested correct spellings of the word can be determined from the dictionary of the source language. Further, in block 360 each suggested correctly spelled word in the source language can be translated into a secondary language by reference to a dictionary of the secondary language. Finally, in block 370 the suggested each correctly spelled word and its secondary language translation can be displayed.

In block 380, one of the suggested correctly spelled words can be selected in a display of the suggested correctly spelled words. In block 390, either a definition of the selected suggested correctly spelled word, one or more synonyms of the selected suggested correctly spelled word, or both can be retrieved from the dictionary of the source language. Concurrently, either a definition of the translation of the selected suggested correctly spelled word, one or more synonyms of the translation of the selected suggested correctly spelled word, or both can be retrieved from the dictionary of the secondary language. Thereafter, in block 390 both definitions, synonyms or the definitions and synonyms in both the source language and secondary language can be displayed.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for multi-lingual spell checking of a block of text, the method comprising:
spell checking text of a source language in a block of text of the source language in a computer program executing in memory of a host computer;
locating suggested correctly spelled text for the spell checked text in a dictionary for the source language;
translating the located suggested correctly spelled text into a translation of the located suggested correctly spelled text in a secondary language; and,
displaying both the located suggested correctly spelled text in the source language and the translation of the located suggested correctly spelled text in the secondary language in connection with the spell checked text.

2. The method of claim 1, wherein the text is a word.

3. The method of claim 1, further comprising:
selecting the located suggested correctly spelled text in the source language;
locating in the dictionary for the source language a synonym for the located suggested correctly spelled text in the source language;
additionally locating in a dictionary for the secondary language a synonym for the translation of the located suggested correctly spelled text in the secondary language; and,
displaying both the synonym in the source language and the synonym in the secondary language in connection with the spell checked text.

4. The method of claim 1, further comprising:
selecting the located suggested correctly spelled text in the source language;
locating in the dictionary for the source language a definition for the located suggested correctly spelled text in the source language;
additionally locating in a dictionary for the secondary language a definition for the translation of the located suggested correctly spelled text in the secondary language; and,
displaying both the definition in the source language and the definition in the secondary language in connection with the spell checked text.

5. A spell checker data processing system comprising:
a host computer with at least one processor and memory;
a computer program executing in the host computer and accepting text input for processing in the computer program;
a dictionary in a source language, a dictionary in a secondary language and a translation table for translating words in the source language to words in the secondary language; and,
a multi-lingual spell checker executing in the memory of the host computer being coupled to each of the dictionaries, the translation table and the computer program and comprising program code enabled to spell check text in a source language in the text input, to located suggested correctly spelled text for the spell checked text in the dictionary for the source language, to translate the located suggested correctly spelled text into a translation of the located suggested correctly spelled text in the secondary language, and to display both the located suggested correctly spelled text in the source language and the translation of the located suggested correctly spelled text in the secondary language in connection with the spell checked text.

6. The system of claim 5, wherein the text is a word.

7. The system of claim 5, wherein the program code is further enabled to select the located suggested correctly spelled text in the source language, to locate in the dictionary for the source language a synonym for the located suggested correctly spelled text in the source language, to additionally locate in the dictionary for the secondary language a synonym for the translation of the located suggested correctly spelled text in the secondary language, and to display both the synonym in the source language and the synonym in the secondary language in connection with the spell checked text.

8. The system of claim 5, wherein the program code is further enabled to select the located suggested correctly spelled text in the source language, to locate in the dictionary for the source language a definition for the located suggested correctly spelled text in the source language, to additionally locate in the dictionary for the secondary language a definition for the translation of the located suggested correctly spelled text in the secondary language, and to display both the definition in the source language and the definition in the secondary language in connection with the spell checked text.

9. A computer program product for multi-lingual spell checking of a block of text, the computer program product comprising:
a computer readable storage medium having computer readable program code embodied therewith, the computer readable program code comprising:
computer readable program code for spell checking text or a source language in a block of text of the source language in a computer program executing in memory of a host computer;
computer readable program code for locating suggested correctly spelled text for the spell checked text in a dictionary for the source language;
computer readable program code for translating the located suggested correctly spelled text into a translation of the located suggested correctly spelled text in a secondary language; and,
computer readable program code for displaying both the located suggested correctly spelled text in the source language and the translation of the located suggested correctly spelled text in the secondary language in connection with the spell checked text.

10. The computer program product of claim 9, wherein the text is a word.

11. The computer program product of claim 9, further comprising:
computer readable program code for selecting the located suggested correctly spelled text in the source language;
computer readable program code for locating in the dictionary for the source language a synonym for the located suggested correctly spelled text in the source language;
computer readable program code for additionally locating in a dictionary for the secondary language a synonym for the translation of the located suggested correctly spelled text in the secondary language; and,
computer readable program code for displaying both the synonym in the source language and the synonym in the secondary language in connection with the spell checked text.

12. The computer program product of claim 9, further comprising:
computer readable program code for selecting the located suggested correctly spelled text in the source language;
computer readable program code for locating in the dictionary for the source language a definition for the located suggested correctly spelled text in the source language;
computer readable program code for additionally locating in a dictionary for the secondary language a definition for the translation of the located suggested correctly spelled text in the secondary language; and,
computer readable program code for displaying both the definition in the source language and the definition in the secondary language in connection with the spell checked text.
